(19) United States
(12) Patent Application Publication
(10) Pub. No.: US 2017/0287342 A1
(43) Pub. Date: Oct. 5, 2017

(54) IMAGE DISPLAY

(71) Applicant: BAE Systems plc, London (GB)

(72) Inventor: Steven James HODGE, Lancashire (GB)

(73) Assignee: BAE Systems PLC, London (GB)

(21) Appl. No.: 15/506,921

(22) PCT Filed: Aug. 25, 2015
(86) PCT No.: PCT/GB2015/052449

§ 371 Date: Feb. 27, 2017

(30) Foreign Application Priority Data
Aug. 29, 2014 (GB) 1415282.1

(51) Int. Cl. G08G 5/00; G01C 23/00; G06T 11/60; B64D 45/08; G02B 27/01; G09G 5/377

(52) U.S. Cl. CPC G08G 5/0047; G02B 27/0172; G09G 5/377; G06T 11/60; B64D 45/08; G01C 23/005; G08G 5/0021; G02B 2027/0198; G09G 2380/12; G09G 2340/12; G09G 2340/14

(57) ABSTRACT

A method for displaying an image to a pilot (20) of an aircraft (2). The method comprises: displaying, by a helmet mounted display (HMD) (24), to the pilot (20), an image comprising initial image components including a first image component (34); determining that the helmet mounted display (24) is offset from a desired position for the helmet mounted display (24); determining, by one or more processors (26), a specification for a further image component (50); and displaying, by the helmet mounted display (24), to the pilot (20), an image comprising at least the first image component (34) and the further image component (50). The further image component (50) has a fixed position with respect to the first image component (34) and indicates one or more alternative positions for the first image component (34).

### FIELD OF THE INVENTION

The present invention relates to the display of images to pilots of aircraft.

### BACKGROUND

Helmet Mounted Displays (HMD), or head mounted displays, are display devices worn on the head of a user as part of a helmet. The HMD may be positioned in front of one or both of the user's eyes. Typically, the HMD is configured to reflect images projected on to it, while at the same time allowing the user to see through it.

It is known to use HMDs to display information to the pilot of an aircraft to facilitate the pilot in performing an operation such as landing the aircraft. Such information is often referred to as “HMD symbology”.

HMD symbology for facilitating a pilot of an aircraft to land that aircraft on an aircraft carrier includes: Ship Referenced Velocity Vectors (SRVVs), Ship Referenced Velocity Vector scales (SRVV scales), Flight Path Markers (FPMs), and horizon bars.

Many factors may cause the HMD symbology displayed to a pilot to be erroneous or inaccurate. Such errors and inaccuracies may increase the likelihood of aircraft damage as well as pilot or ground crew injury. Thus, there is a need to determine when displayed HMD symbology is erroneous, and to mitigate the effects of the error.

### SUMMARY OF THE INVENTION

In a first aspect, the present invention provides a method for displaying an image to a pilot of an aircraft. The method comprises: displaying, by a helmet mounted display, to the pilot of the aircraft, an image comprising one or more initial image components, the one or more initial image components including a first image component; providing, to a processor (or processors), an indication that the helmet mounted display is offset from a desired position for the helmet mounted display (e.g. relative to the pilot), the desired position of the helmet mounted display being a position in which, when the pilot controls the aircraft to perform a predefined operation, from the pilot's point of view, an initial image component displayed on the helmet mounted display is at a predefined position relative to one or more objects or features that are remote from the aircraft; determining, by the processor, a specification for a further image component; and displaying, by the helmet mounted display, to the pilot of the aircraft, an image comprising at least the first image component and the further image component. The further image component has a fixed position on the display with respect to the first image component and indicates, to the pilot, one or more alternative positions on the helmet mounted display for the first image component.

Displaying the image comprising at least the first image component and the further image component may be performed in response to the indication being received by the processor(s).

Determining the specification for the further image component may be performed in response to the indication being received by the processor(s).

The step of determining the specification for the further image component may comprise providing a value for a distance by which the helmet mounted display is offset from the desired position for the helmet mounted display, and, using the provided distance value, determining the specification for the further image component.

The further image component may further indicate, to the pilot, the relative probabilities of the one or more alternative positions for the first image component being the same as the position that the first image component would have if, were the pilot to control the aircraft to perform the predefined operation, from the pilot's point of view, an initial image component was at the predefined position relative to the one or more objects or features that are remote from the aircraft.

The further image component may indicate, to the pilot, a plurality of alternative positions on the helmet mounted display for the first image component with respect to the objects or features that are remote from the aircraft.

The step of determining the specification for the further image component may comprise: for each of the alternative positions for the first image component, providing a value for a probability that that position for the first image component is the same as the position that the first image component would have if, were the pilot to control the aircraft to perform the predefined operation, from the pilot's point of view, an initial image component was at the predefined position relative to the one or more objects or features that are remote from the aircraft; and, using the provided probability values, determining the specification for the further image component.

The further image component may be a V-shaped symbol.

The length of the V-shaped symbol may indicate a range alternative positions for the first image component with respect to the objects or features that are remote from the aircraft, the length of the V-shaped symbol being a distance between the tip of the V-shaped symbol and the ends of the arms of the V-shaped symbol.

The distance between the arms of the V-shaped symbol at a point along the length of the V-shaped symbol may indicate a relative probability that the alternative position for the first image component corresponding to that point along the length of the V-shaped symbol is the same as the position that the first image component would have if, were the pilot to control the aircraft to perform the predefined operation, from the pilot's point of view, an initial image component was at the predefined position relative to the one or more objects or features that are remote from the aircraft.

The first image component may be a Ship Reference Velocity Vector scale for aiding the pilot to land the aircraft.

The first image component may be a linear object that extends horizontally across at least part of the display.

The further image component may indicate one or more alternative vertical positions on the helmet mounted display for the first image component.

The step of providing the indication to the processor may comprise: controlling, by the pilot, the aircraft to operate in a straight and level state; determining that, during the straight and level state, one or more of the initial image components do not, from the pilot's point of view, coincide with a corresponding object or feature remote from the aircraft; and, responsive to the determination that, from the pilot's point of view, one or more initial image components do not coincide with a corresponding object or feature remote from the aircraft, providing, to the processor, the indication.

The step of determining that, during the straight and level state, one or more initial image components do not, from the pilot's point of view, coincide with a corresponding object or feature remote from the aircraft may comprise determining, by the pilot, that, during the straight and level state, one or more horizon bars displayed on the helmet mounted display do not, from the pilot's point of view, coincide with the horizon as seen by the pilot through the helmet mounted display.

The processor may be wholly located onboard the aircraft.

The method may further comprise controlling, by the pilot, the aircraft dependent upon the displayed further image component.

In a further aspect, the present invention provides apparatus for displaying an image to a pilot of an aircraft. The apparatus comprises: a helmet mounted display configured to display, to the pilot of the aircraft, an image comprising one or more initial image components including a first image component; and one or more processors configured to: receive an indication that the helmet mounted display is offset from a desired position for the helmet mounted display, the desired position of the helmet mounted display being a position in which, when the pilot controls the aircraft to perform a predefined operation, from the pilot's point of view, an initial image component displayed on the helmet mounted display is at a predefined position relative to one or more objects or features that are remote from the aircraft, and determine a specification for a further image component. The helmet mounted display is further configured to display, to the pilot of the aircraft, an image comprising the first image component and the further image component. The further image component has a fixed position on the display with respect to the first image component and indicates, to the pilot, one or more alternative positions on the helmet mounted display for the first image component.

In a further aspect, the present invention provides an aircraft comprising apparatus in accordance with the preceding aspect.

In a further aspect, the present invention provides a program or plurality of programs arranged such that when executed by a computer system or one or more processors it/they cause the computer system or the one or more processors to operate in accordance with the method of any of the above aspects.

In a further aspect, the present invention provides a machine readable storage medium storing a program or at least one of the plurality of programs according to the preceding aspect.

### BRIEF DESCRIPTION OF THE DRAWINGS

FIG. 1 is a schematic illustration (not to scale) showing a scenario in which an embodiment of an aircraft landing aid is implemented;

FIG. 2 is a schematic illustration (not to scale) showing an aircraft and illustrating a helmet mounted display (HMD) system;

FIG. 3 is a schematic illustration (not to scale) showing helmet mounted display symbology as seen by a pilot during the landing of the aircraft;

FIG. 4 is a process flow chart showing certain steps of a process by which certain factors that are adversely affecting the displayed HMD symbology may be determined and mitigated;

FIG. 5 is a schematic illustration (not to scale) showing a further SRVV scale displayed on the helmet mounted display;

FIG. 6 is a schematic illustration (not to scale) showing an offset feature displayed on the helmet mounted display; and

FIG. 7 is a schematic illustration (not to scale) showing a ship speed error scale displayed on the helmet mounted display.

### DETAILED DESCRIPTION

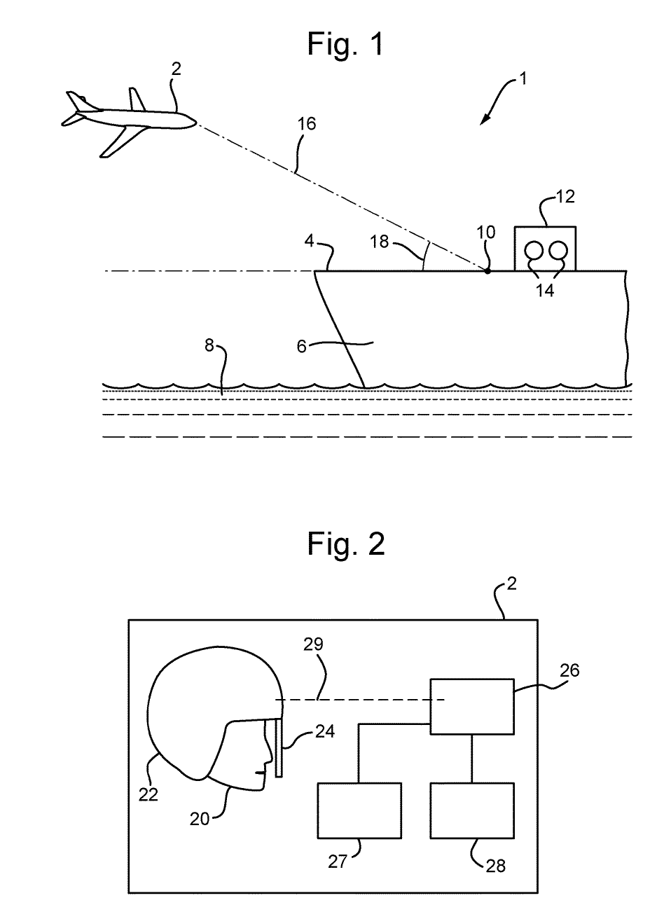

FIG. 1 is a schematic illustration (not to scale) showing a scenario 1 in which an embodiment of an aircraft landing aid is implemented.

In the scenario 1, an aircraft 2 is to land on a runway 4 of an aircraft carrier 6. The aircraft carrier 6 is afloat on a body of water 8, e.g. an ocean or sea. A desired or optimum landing position for the aircraft 2 on the runway 4 is hereinafter referred to as the “optimum landing position” and is indicated in FIG. 1 by the reference numeral 10.

A glide path indicator 12 is located onboard the aircraft carrier 6. The glide path indicator 12 is a visual landing aid comprising one or more light emitters 14 (e.g. “aim lights”) which define glide path information for use by a pilot of the aircraft 2 through a helmet-mounted display. The glide path indicator 12 may, for example, be a “Bedford Array”. The light emitters 14 may be, for example, pulsating visual approach slope indicators (PVASIs).

The light emitters 14 of the glide path indicator 12 indicate, to the pilot of the aircraft 2, a glide path 16. The glide path 16 is oblique, i.e. at an angle, to the runway 4. The angle between the glide path 16 and the runway 4 is indicated in FIG. 1 by the reference numeral 18.

The glide path 16 is such that, if the glide path 16 is followed by the aircraft 2, the aircraft 2 would land on the runway 4 at the optimum landing position 10.

The angle 18 between the glide path 16 and the runway 4 is such that, if the glide path 16 is followed by the aircraft 2, the aircraft 2 would have a descent profile corresponding to a desired, or optimum, landing. In this scenario 1, the angle 18 is 7°. However, in other embodiments, the angle 18 may be a different value e.g. 3°. Preferably, the angle is between 2° and 8°.

FIG. 2 is a schematic illustration (not to scale) showing the aircraft 2.

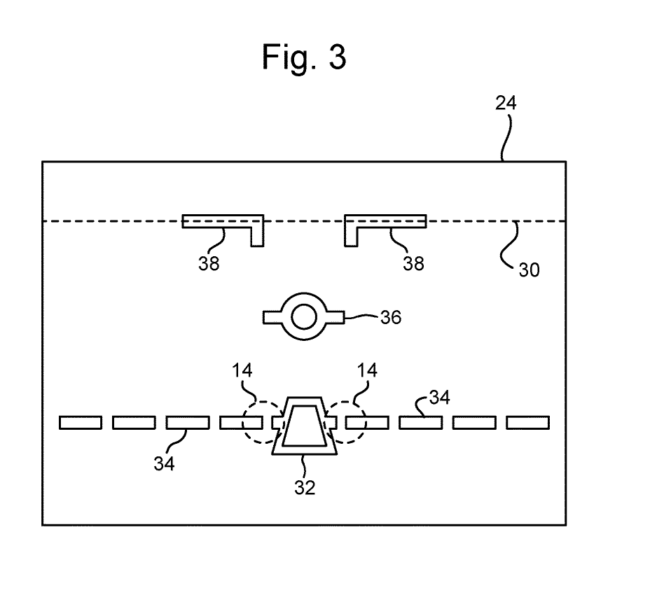

A pilot 20 controls the aircraft 2. A method by which the pilot 20 controls the aircraft 2 to land on the runway 4 is described in more detail later below with reference to FIG. 3.

The aircraft 2 comprises an embodiment of an aircraft landing aid. The landing aid comprises a helmet 22 which is worn by the pilot 20 and includes a helmet mounted display 24. The landing aid further comprises a processor 26, a pilot interface 27, and a transceiver 28.

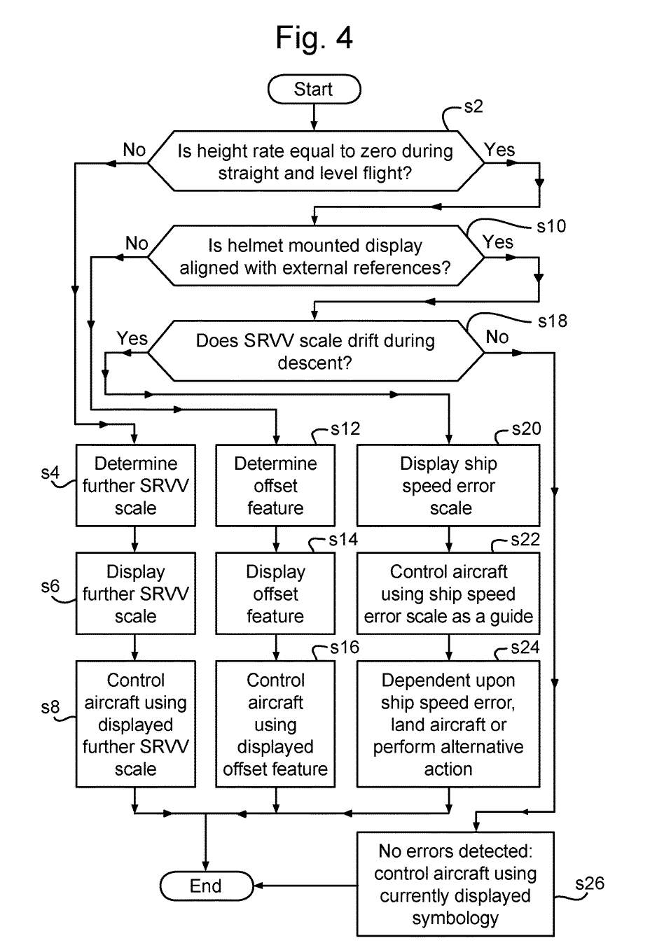

In this embodiment, the processor 26 is coupled to the pilot interface 27. As described in more detail later below with reference to FIG. 4, information may be input by the pilot 20 to the pilot interface 27, which may then be sent from the pilot interface 27 to the processor 26.

Also, the processor 26 is further coupled to the transceiver 28. As described in more detail later below with reference to FIG. 4, information received by the transceiver 28, for example from the aircraft carrier 6, may be sent from the transceiver 28 to the processor 26.

In this embodiment, the processor 26 is configured to process information received from the pilot interface 27 and/or the transceiver 28 so as to determine display information to be displayed to the pilot 20. This display information may facilitate the pilot 20 in landing the aircraft 2 on the runway 4 as described in more detail later below with reference to FIG. 3.

The processor 26 is coupled to the helmet 22 via a communications link 29 in such a way that display information determined by the processor 26 may be sent from the processor 26 to the helmet 22.

In some embodiments, the communications link 29 is a wired communications link. The helmet 22 may be plugged into the aircraft systems via a plug located at the pilot's seat.

The helmet 22 is configured to display the received display information to the pilot 20 on the helmet mounted display 24.

In this embodiment, the helmet mounted display 24 is an optical head-mounted display (OHMD) that has the capability of reflecting projected images as well as allowing the pilot 20 to see through it.

FIG. 3 is a schematic illustration (not to scale) showing the helmet mounted display 24, and certain objects which are seen through the helmet mounted display 24, as seen by the pilot 20 during the landing of the aircraft 2 on the runway 4. The helmet mounted display 24 displays information that facilitates the pilot 20 to safely land the aircraft 2 on the runway 4.

Objects and features that the pilot 20 may see through the helmet mounted display 24 are depicted in FIG. 3 using dotted lines. In particular, in this embodiment, the pilot 20 can see the light emitters 14 of the glide path indicator 12 and the horizon 30 through the helmet mounted display 24. The pilot 20 may see other additional objects/features through the helmet mounted display 24, but these have been omitted from FIG. 3 for reasons of clarity and ease of depiction.

Objects and features that are projected onto the helmet mounted display 24 and may thusly be seen by the pilot 20 are depicted in FIG. 3 using solid lines. Objects and features that are projected onto the helmet mounted display 24 (i.e. image components) are also known as “Helmet Mounted Display (HMD) symbology”. In this embodiment, the HMD symbology includes: a Ship Referenced Velocity Vector (SRVV) 32; a Ship Referenced Velocity Vector glide slope scale, hereinafter referred to as the “SRW scale” and indicated by the reference numeral 34; a Flight Path Marker (FPM) 36, and a plurality of horizon bars 38.

In this embodiment, the SRVV 32 appears on the helmet mounted display 24 as a substantially trapezium-shaped icon or object having two opposite horizontal arms protruding from it. The SRVV 32 is positioned on the helmet mounted display 24 so as to indicate to the pilot 20 the instantaneous glideslope of the aircraft 2 relative to the runway 4 of the moving aircraft carrier 6. In this embodiment, this instantaneous glideslope of the aircraft 2 relative to the runway 4 is different from the glideslope relative to the Earth, due to the aircraft carrier's speed through the water 8.

In this embodiment, the SRVV scale 34 appears as a dashed line horizontally across the helmet mounted display 24. The SRVV scale 34 is positioned on the helmet mounted display 24 at a predefined depression angle (i.e. vertically displaced) below the horizon bars 38. This displacement (i.e. the predefined depression angle) is based upon the angle 18 between the desired glideslope 16 and the runway 4. For example, the predefined depression angle may be equal to angle 18.

In this embodiment, the FPM 36 appears as a circle having two opposite horizontal arms protruding from it. The FPM 36 indicates the aircraft's flight path relative to the Earth. In some embodiments, the position on the display 24 of the SRVV 32 and/or the SRVV scale 34 is dependent upon the position on the display 24 of the FPM 36. In some embodiments, the SRW 32 is offset from the FPM 36 by an amount proportional to the ship's speed. In some embodiments, if the ship 6 is stationary, the SRVV 32 and the FPM 36 are coincident on the display 24.

In this embodiment, horizon bars 38 appear as substantially L-shaped objects having longer horizontal arms and shorter vertical arms. The horizon bars 38 are the reference position of a Climb/Dive ladder of the aircraft 2. Preferably, the horizon bars 38 remain coincident with the real-world horizon, and may be used as a reference for determining the aircraft flight path via the FPM 36 or SRVV 32.

In an example operation, in order to perform an “optimum” landing of the aircraft 2 on the runway 4, firstly the pilot 20 controls the aircraft 2 to fly in a substantially straight and level state until he/she sees the SRVV scale 34 displayed by the helmet mounted display 24 coincide with (i.e. pass through) the two light emitters 14 seen through the helmet mounted display 24. The SRVV scale 34 coinciding with the light emitters 14 is shown in FIG. 3.

Once the SRVV scale 34 is coincident with the light emitters 14, the pilot 20 begins the descent of the aircraft 2 towards the runway 4 (i.e., the pilot 20 “tips over” the aircraft 2).

During the aircraft's descent, the pilot 20 controls the aircraft 2 (i.e. controls the angle of descent of the aircraft 2) such that the SRVV 32 is coincident with the SRVV scale 34. In this example operation, the SRVV 32 is deemed to be coincident with the SRW scale 34 if the horizontal arms of the SRVV 32 are aligned along the SRVV scale 34, for example, as shown in FIG. 3. In this example, the SRVV 32 is also positioned between the light emitters 14 seen through the helmet mounted display 24.

In this example, the SRVV 32 and the SRVV scale 34 are such that, when the SRW 32, the SRW scale 34, and the light emitters 14 are coincident, as shown in FIG. 3 and described above, the aircraft 2 is established on the desired 7° glide path towards the runway 4.

Thus, once the SRVV 32 is coincident with the SRVV scale 34, the pilot 20 controls the aircraft 2 to keep the SRVV 32 coincident with the SRVV scale 34, thereby maintaining the aircraft 2 on the desired 7° glide path towards the runway 4.

The aircraft 2 is controlled in this way until it has landed on the runway 4. FIG. 3 shows an example “sight picture” that the pilot 20 should be attempting to achieve during the landing operation.

During this example operation, the horizon bars 38 overlap with the horizon seen through the helmet mounted display 24.

In some landing operations, the SRVV 32 renders the FPM 36 redundant. The FPM 36 may be removed from the symbology displayed to the pilot 20. However, in some embodiments, the FPM 36 is displayed during the landing operation and provides, to the pilot 20, confidence that the SRVV 32 is being displayed in the correct position on the helmet mounted display 24.

Many factors may adversely affect the accuracy of the displayed HMD symbology. FIG. 4 is a process flow chart showing certain steps of a process by which certain factors that are adversely affecting the displayed HMD symbology may be determined and mitigated.

It should be noted that certain of the process steps depicted in the flowchart of FIG. 4 and described below may be omitted or such process steps may be performed in differing order to that presented above and shown in FIG. 4. Furthermore, although all the process steps have, for convenience and ease of understanding, been depicted as discrete temporally-sequential steps, nevertheless some of the process steps may in fact be performed simultaneously or at least overlapping to some extent temporally.

At step s2, whilst the aircraft 2 is operating in a substantially straight and level state, the pilot 20 determines whether or not the height rate of the aircraft 2 is equal to zero. Operating the aircraft in a straight and level state may include the pilot 20 controlling the aircraft 2 such that the FPM 36 is positioned onto the horizon 30.

The height rate of the aircraft 2 may, for example, be determined by the processor 26 or a different processing device onboard the aircraft 2 using one or more measurements taken by a sensor system on board the aircraft 2.

The height rate of the aircraft 2 may, for example, be displayed to the pilot 2 on the helmet mounted display 2, or on a control panel in the cockpit of the aircraft 2.

If, whilst flying straight and level, the height rate of the aircraft 2 is not equal to zero, in this embodiment it is determined that an error has occurred with the Internal Navigation System (INS) of the aircraft 2, for example, one or more of the sensors used by the aircraft's navigation system may have malfunctioned. The method then proceeds to step s4.

However, if, whilst flying straight and level, the height rate of the aircraft 2 is equal to zero, in this embodiment it is determined that no INS error has occurred and the method proceeds to step s10. Step s10 will be described in more detail later below after a description of steps s4 to s8.

At step s4, the processor 26 determines a further SRVV scale. This may be performed by the processor 26 in response to the processor 26 receiving an indication from the pilot 20, via the interface 27, that, whilst flying straight and level, the height rate of the aircraft 2 is not equal to zero.

The determination of the further SRVV scale may, for example, be performed as follows.

Firstly, the processor 26 may determine a “correct” height rate for the aircraft 2. The correct height rate for the aircraft 2 may be expressed as:

\dot{h}_{correct}=(v_{aircraft}−vₛₕᵢₚ)tan γ_{SRVV}

where:
v_{aircraft} is the velocity of the aircraft 2, which may be provided to the processor 26 from one or more aircraft sub systems;
vₛₕᵢₚ is the velocity of the aircraft carrier 6, which may be provided to the processor 26 by the aircraft carrier 6 via the transceiver 28, or by the pilot 20 inputting the aircraft carrier's speed using the interface 27 based on communications from the aircraft carrier 6; and
γ_{SRVV} is the desired glide path angle 18 (i.e. 7° in this embodiment).

The processor 26 may then determine the height rate error, which may be expressed as:

\dot{h}ₑᵣᵣₒᵣ=\dot{h}ᵢₙₛ−\dot{h}_{correct}

where \dot{h}ᵢₙₛ is the height rate of the aircraft 2 as output by the INS of the aircraft 2.

The processor 26 may then determine a new glide path angle, for example, using the following equation:

$${γ}_{SRVVerror} = arctan ( \frac{{\dot{h}}_{error}}{( {v}_{aircraft} - {v}_{ship} )} )$$

where γ_{SRVVerror} is an error value that may be added/subtracted from the 7° glide slope, i.e., from γ_{SRVV} so as to provide the new glide path angle.

For example, γ_{newSRVV}=γ_{SRVV}+/−γ_{SRVVerror}.

The new glide path angle γ_{newSRVV} is then used by the processor 26 to determine the further SRVV scale. In this embodiment, the further SRVV scale is equal to the current SRVV scale 34 shifted or displaced on the helmet mounted display 24 by a vertical distance proportional to \dot{h}ₑᵣᵣₒᵣ.

At step s6, the processor 26 displays the determined further SRVV scale on the helmet mounted display 24.

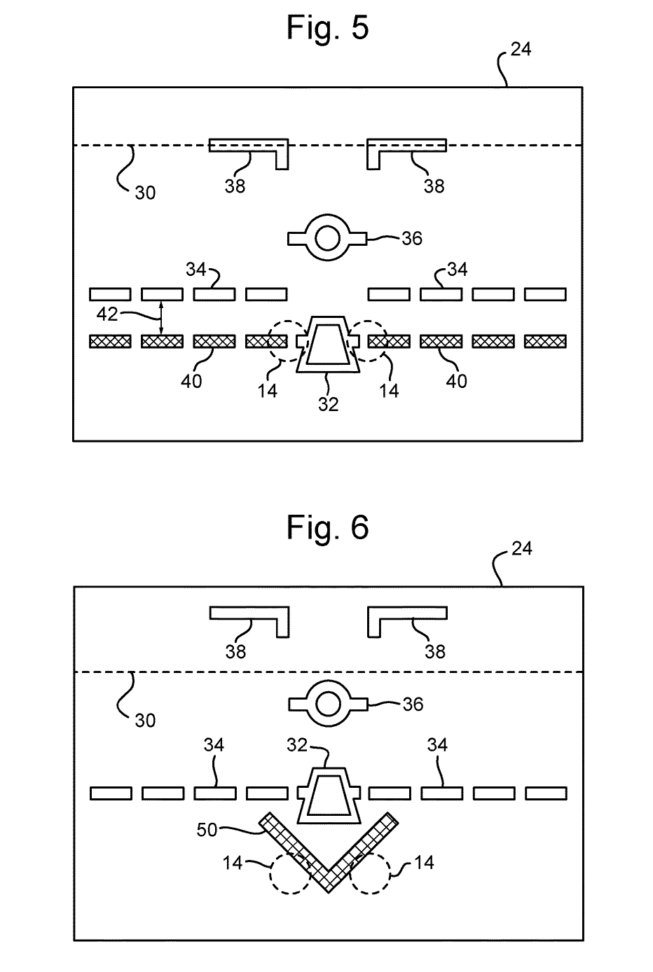

FIG. 5 is a schematic illustration (not to scale) showing the further SRVV scale 40 displayed on the helmet mounted display 24. FIG. 5 shows the helmet mounted display 24, and certain objects/features which are seen through the helmet mounted display 24, as seen by the pilot 20 during the landing of the aircraft 2. The further SRVV scale 40 is an additional image component (i.e. additional HMD symbology) that is displayed to the pilot 20 on the helmet mounted display 24.

In this embodiment, the further SRW scale 40 appears as a dashed line horizontally across the helmet mounted display 24 (i.e. the further SRVV scale 40 is parallel with the SRVV scale 34). The further SRVV scale 40 is shown in FIG. 5 as a solid, filled-in, dashed line to help the reader distinguish it from the SRW scale 34.

The distance between the SRVV scale 34 and the further SRVV scale 40 is indicated in FIG. 5 by a double headed arrow and the reference numeral 42. In this embodiment, this distance 42 is proportional to \dot{h}ₑᵣᵣₒᵣ.

FIG. 5 shows both the SRW scale 34 and the further SRW scale 40 for ease of understanding, however in some embodiments, the further SRVV scale 40 replaces the previous SRVV scale 34, and the SRW scale 34 is not displayed to the pilot 20. This tends to minimise the likelihood of the pilot 20 being confused by multiple SRVV scales being displayed.

At step s8, the pilot 20 controls the aircraft 2 using the further SRVV scale 40. In particular, in order to perform a landing operation, the pilot 20 controls the aircraft 2 to fly in a substantially straight and level state until he/she sees the further SRVV scale 40 coincide with the two light emitters 14 seen through the helmet mounted display 24. The further SRVV scale 40 coinciding with the light emitters 14 is shown in FIG. 5. The pilot 20 then controls the aircraft 2 to descend towards the runway 4, as described in more detail earlier above with reference to FIG. 3. The aircraft 2 is then controlled as normal by the pilot 20 and the aircraft 2 is landed on the runway 4.

After step s8, the process of FIG. 4 ends.

Returning now to the case where, at step s2, it is determined that, whilst flying straight and level, the height rate of the aircraft 2 is equal to zero, at step s10, the pilot 20 determines whether or not the HMD symbology displayed on the helmet mounted display 24 aligns with one or more reference features or objects external to the aircraft 2.

For example, the pilot 20 may determine whether or not, while controlling the aircraft 2 to fly in a straight and level state, the horizon bars 38 coincide with the horizon 30.

If it is determined that, whilst flying straight and level, the HMD symbology does not align with reference features or objects external to the aircraft 2, in this embodiment it is determined that a “helmet mounted display (HMD) offset” type error has occurred. The method then proceeds to step s12. HMD offset errors may occur, for example, as a result of sensor error, or as a result of the helmet 22 not being correctly fitted to, or moving with respect to, the pilot's head 20.

However, if it is determined that, whilst flying straight and level, the HMD symbology correctly aligns with reference features or objects external to the aircraft 2, in this embodiment it is determined that no HMD offset error has occurred and the method proceeds to step s18. Step s18 will be described in more detail later below after a description of steps s12 to s16.

At step s12, the processor 26 determines a specification of an “offset feature” to be displayed to the pilot 20. This may be performed by the processor 26 in response to the processor 26 receiving an indication from the pilot 20, via the interface 27, that, whilst flying straight and level, the HMD symbology does not align with reference features or objects external to the aircraft 2.

The offset feature and its determination will be explained in more detail later below with reference to FIG. 6.

At step s14, the processor 26 displays the determined offset feature on the helmet mounted display 24.

FIG. 6 is a schematic illustration (not to scale) showing the offset feature 50 displayed on the helmet mounted display 24. FIG. 6 shows the helmet mounted display 24, and certain objects/features which are seen through the helmet mounted display 24, as seen by the pilot 20 during the landing of the aircraft 2. The offset feature 50 is an additional image component (i.e. additional HMD symbology) that is displayed to the pilot 20 on the helmet mounted display 24.

In this embodiment, an HMD offset type error means that, from the pilot's point of view, all HMD symbology displayed on the helmet mounted display 24 is shifted either up or down (i.e. vertically) with respect to the objects/features viewed through the helmet mounted display 24 (e.g. the light emitters 14). The offset feature 50 indicates to the pilot 20 a range of possible actual positions that the SRVV scale 34 may have with respect to the objects/features viewed through the helmet mounted display 24. Thus, the offset feature 50 is, in effect, an “error bar” for the SRVV scale 34.

In this embodiment, the offset feature 50 appears as a V-shaped object or icon. The offset feature 50 is shown in FIG. 5 as solid, filled-in V-shaped object.

The offset feature 50 indicates possible actual positions of the SRVV scale 34 with respect to the objects/features external to the aircraft 2. In particular, in this embodiment the actual position of the SRVV scale 34 with respect to an object external to the aircraft 2 may be any horizontal line that passes through the offset feature 50. Thus, the larger the size of the offset feature 50 (i.e. the larger the distance between the SRVV scale 34 and the tip of the V-shaped offset feature 50), the larger the range of possible true positions of the SRVV scale 34 relative to the objects/features external to the aircraft 2.

The size of the offset feature 50 that is displayed to the pilot 20 may be determined by the processor 26 using any appropriate parameter values. For example, using properties of the helmet 22 and/or the pilot 20 (e.g. the size and shape of the pilot's head), the processor 26 may determine (e.g. by looking up in a database) a value for a maximum or most likely HMD offset by which the HMD symbology may be shifted with respect to objects/features external to the aircraft 2. The processor 26 may then specify an appropriately sized offset feature 50. Typically, the offset feature 50 is indicative of an HMD offset of between 0.5° and 3°, and more typically of about 1°.

In this embodiment, the width of the V-shaped offset feature 50 along a particular horizontal line that passes through the offset feature 50 (i.e. the distance between the two arms of the V-shaped offset feature 50 along that horizontal line) is indicative of the probability that that horizontal line is the actual position of the SRVV scale 34 with respect to the objects/features external to the aircraft 2. Thus, the larger the angle between the arms of the V-shaped offset feature 50, the more likely it is that the actual position of the SRVV scale 34 is at or close to the currently displayed SRVV scale 34.

The size of the angle between the arms of the V-shaped offset feature 50 may be determined by the processor 26 using any appropriate parameter values. For example, using properties of the helmet 22 and/or the pilot 20 (e.g. the size and shape of the pilot's head), the processor 26 may determine the probability of an HMD offset error occurring. The processor 26 may then specify an appropriately shaped offset feature 50.

In this embodiment, the offset feature 50 is associated with the SRVV scale 34 and has a fixed position on the helmet mounted display 24 with respect to the SRW scale 34. Thus, if the SRVV scale 34 moves on the helmet mounted display 34, the offset feature 50 moves correspondingly.

At step s16, the pilot 20 controls the aircraft 2 dependent upon the offset feature 50. In particular, in order to perform a landing operation, the pilot 20 controls the aircraft 2 to fly in a substantially straight and level state until he/she sees the two light emitters 14 (seen through the helmet mounted display 24) coincide with a horizontal line that passes through the offset feature 50 and/or the SRVV scale 34. The light emitters 14 coinciding with a horizontal line that passes through the offset feature 50 is shown in FIG. 5. The pilot 20 then controls the aircraft 2 to descend towards the runway 4, as described in more detail earlier above. The aircraft 2 is then controlled as normal by the pilot 20 and the aircraft 2 is landed on the runway 4. The pilot 20 uses his/her experience, as well as the size and shape of the offset feature 50, to determine an appropriate “tipping point” at which to begin the aircraft's descent.

After step s16, the process of FIG. 4 ends.

Returning now to the case where, at step s10, it is determined that, whilst flying straight and level, the HMD symbology correctly aligns with reference features or objects external to the aircraft 2, at step s18, the pilot 20 begins his/her descent as normal (i.e. when the SRVV scale 34 aligns with the light emitters 14) and, during the descent and when the aircraft 2 is established on the glide path 16, determines whether or not the SRVV scale 34 drifts (i.e. moves vertically) with respect to the light emitters 14.

If it is determined that, during the aircraft's descent, the SRVV scale 34 drifts with respect to the light emitters 14, in this embodiment it is determined that there is an error in the speed of the aircraft carrier 6 used by the processor 26 to calculate the SRVV scale 34. Such an error may result from errors in the measurement of the aircraft carrier's speed and/or an error in the speed communicated to the aircraft 2 from the aircraft carrier 6. The method then proceeds to step s20.

However, if it is determined that, during the aircraft's descent, the SRVV scale 34 does not drift with respect to the light emitters 14, in this embodiment it is determined that there is no error in the speed value used by the processor 26 to determine the SRVV scale 34 and the method proceeds to step s26. Step s26 will be described in more detail later below after a description of steps s20 to s24.

At step s20, a “ship speed error scale” is displayed to the pilot 20. This may be performed by the processor 26 in response to the processor 26 receiving an indication from the pilot 20, via the interface 27, that, during the aircraft's descent, the SRVV scale 34 drifts with respect to the light emitters 14.

In this embodiment, the ship speed error scale is displayed to the pilot only if, during the aircraft's descent, the SRVV scale 34 drifts with respect to the light emitters 14. However, in other embodiments, the ship speed error scale is displayed to the pilot 20 only if one or more different criteria are satisfied instead of or in addition to SRW scale 34 drift. In some embodiment, the ship speed error scale is displayed to the pilot during the descent of the aircraft 2 irrespective of whether or not the SRVV scale 34 drifts with respect to the light emitters 14.

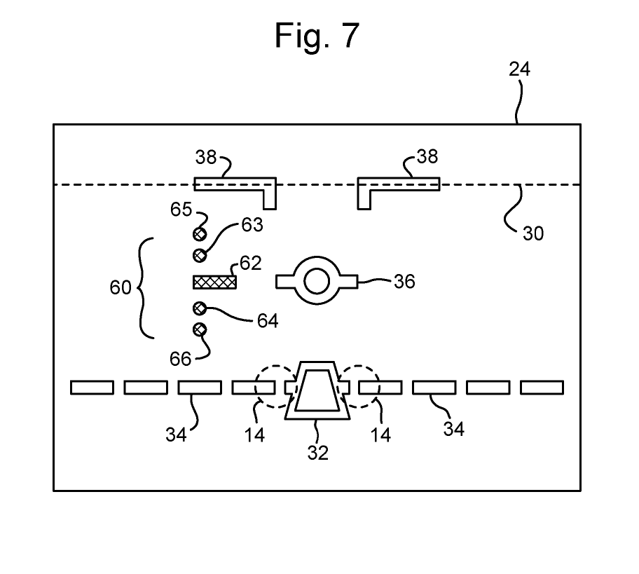

FIG. 7 is a schematic illustration (not to scale) showing the ship speed error scale 60 displayed on the helmet mounted display 24. FIG. 7 shows the helmet mounted display 24, and certain objects/features which are seen through the helmet mounted display 24, as seen by the pilot 20 during the landing of the aircraft 2. The ship speed error scale 60 is an additional image component (i.e. additional HMD symbology) that is displayed to the pilot 20 on the helmet mounted display 24.

In this embodiment, the ship speed error scale 60 comprises a horizontal dash 62, a first dot 63, a second dot 64, a third dot 65, and a fourth dot 66. The ship speed error scale 60 is shown in FIG. 7 as solid, filled-in symbology.

In this embodiment, the position of the ship speed error scale 60 on the helmet mounted display 24 is fixed relative to the horizon bars 38. In other embodiments, the position of the ship speed error scale 60 on the helmet mounted display 24 may be fixed relative to different HMD symbology instead of or in addition to the horizon bars 38.

In this embodiment, the dash 62 is a horizontal line that is aligned with the position on the helmet mounted display 24 that, during the “optimum” landing of the aircraft 2 on the runway 4, the FPM 36 would have if the speed of the aircraft carrier (i.e. ship speed), provided by the aircraft carrier 6 to the processor 26 and used by the processor 26 to determine the SRVV scale 34, was correct.

The position of the dash 62 on the helmet mounted display 24 relative to the SRW scale 34 may be determined using the following formula:

$${γ}_{dash} = arctan ( \frac{( {v}_{aircraft} - {v}_{ship} ) tan {γ}_{SRVV}}{{v}_{aircraft}} )$$

where:
γ_{dash} defines the position of the FPM 36 during the aircraft's descent to the aircraft carrier 6 when the SRVV 32 is aligned with the SRW scale 34. γ_{dash} tends to be positioned on the display 24 above the SRVV 32, and offset from the SRVV 32 by an amount proportional to the speed of the aircraft carrier 6;
γ_{aircraft} is the velocity of the aircraft 2, which may be provided to the processor 26 from one or more aircraft sub systems;
γₛₕᵢₚ is the velocity of the aircraft carrier 6 provided to the processor 26 by the aircraft carrier 6 via the transceiver 28; and
γ_{SRVV} is the desired glide path angle 18 (i.e. 7° in this embodiment).

In this embodiment, the first dot 63 is horizontally aligned with the position on the helmet mounted display that, during an “optimum” landing of the aircraft 2 on the runway 4, the FPM 36 would have if the ship speed provided to the processor 26 and used by the processor 26 to determine the SRVV 32 was a first predetermined amount (e.g. 5 knots) more than the actual speed of the aircraft carrier 6, and if the SRVV 32 was aligned with the SRVV scale 34.

The position of the first dot 63 on the helmet mounted display 24 relative to the SRW scale 34 may be determined using the following formula:

$${γ}_{dot 1} = arctan ( \frac{( {v}_{aircraft} - ( {v}_{ship} + {v}_{1} ) ) tan {γ}_{SRVV}}{{v}_{aircraft}} )$$

where:
γ_{dot1} defines the position on the display 24 that the FPM 36 would have during the aircraft's descent to the aircraft carrier 6, if the SRVV 32 was aligned with the SRVV scale 34, and if the ship speed is was v₁ more than that assumed; and
v₁ is the first predetermined amount.

In other words, the first dot 63 indicates a position on the helmet mounted display 24 that the FPM 36 would have if the SRVV 32 was calculated using vₛₕᵢₚ+v₁ as the velocity of the aircraft carrier 6, and, from the pilot's point of view, the SRW scale 34 and the SRW 32 were coincident.

In this embodiment, the second dot 64 is horizontally aligned with the position on the helmet mounted display 24 that, during an “optimum” landing of the aircraft 2 on the runway 4, the FPM 36 would have if the ship speed provided to the processor 26 and used by the processor 26 to determine the SRVV 32 was the first predetermined amount (e.g. 5 knots) less than the actual speed of the aircraft carrier 6, and if the SRVV 32 was aligned with the SRVV scale 34.

The position of the second dot 64 on the helmet mounted display 24 relative to the SRVV scale 34 may be determined using the following formula:

$${γ}_{dot 2} = arctan ( \frac{( {v}_{aircraft} - ( {v}_{ship} - {v}_{1} ) ) tan {γ}_{SRVV}}{{v}_{aircraft}} )$$

where:
γ_{dot2} is defines the position on the display 24 that the FPM 36 would have during the aircraft's descent to the aircraft carrier 6, if the SRVV 32 was aligned with the SRVV scale 34, and if the ship speed is was v₁ less than that assumed. In other words, the second dot 64 indicates a position on the helmet mounted display 24 that the FPM 36 would have if the SRVV 32 was calculated using vₛₕᵢₚ−v₁ as the velocity of the aircraft carrier 6, and, from the pilot's point of view, the SRW scale 34 and the SRVV 32 were coincident.

In this embodiment, the third dot 65 is horizontally aligned with the position on the helmet mounted display 24 that, during an “optimum” landing of the aircraft 2 on the runway 4, the FPM 36 would have if the ship speed provided to the processor 26 and used by the processor 26 to determine the SRVV 32 was a second predetermined amount (e.g. 10 knots) more than the actual speed of the aircraft carrier 6, and if the SRVV 32 was aligned with the SRVV scale 34.

The position of the third dot 65 on the helmet mounted display 24 relative to the SRVV scale 34 may be determined using the following formula:

$${γ}_{dot 3} = arctan ( \frac{( {v}_{aircraft} - ( {v}_{ship} + {v}_{2} ) ) tan {γ}_{SRVV}}{{v}_{aircraft}} )$$

where:
γ_{dot3} is defines the position on the display 24 that the FPM 36 would have during the aircraft's descent to the aircraft carrier 6, if the SRVV 32 was aligned with the SRVV scale 34, and if the ship speed is was v₂ more than that assumed; and
v₂ is the second predetermined amount.

In other words, the third dot 65 indicates a position on the helmet mounted display 24 that the FPM 36 would have if the SRVV scale 34 was calculated using vₛₕᵢₚ+v₂ as the velocity of the aircraft carrier 6, and, from the pilot's point of view, the SRW scale 34 and the SRVV 32 were coincident.

In this embodiment, the fourth dot 66 is horizontally aligned with the position on the helmet mounted display 24 that, during an “optimum” landing of the aircraft 2 on the runway 4, the FPM 36 would have if the ship speed provided to the processor 26 and used by the processor 26 to determine the SRVV 32 was the second predetermined amount (e.g. 10 knots) less than the actual speed of the aircraft carrier 6, and if the SRVV 32 was aligned with the SRW scale 34.

The position of the fourth dot 66 on the helmet mounted display 24 relative to the SRVV scale 34 may be determined using the following formula:

$${γ}_{dot 4} = arctan ( \frac{( {v}_{aircraft} - ( {v}_{ship} - {v}_{2} ) ) tan {γ}_{SRVV}}{{v}_{aircraft}} )$$

where:
γ_{dot4} is defines the position on the display 24 that the FPM 36 would have during the aircraft's descent to the aircraft carrier 6, if the SRVV 32 was aligned with the SRVV scale 34, and if the ship speed is was v₂ less than that assumed.

In other words, the fourth dot 66 indicates a position on the helmet mounted display 24 that the FPM 36 would have if the SRVV 32 was calculated using vₛₕᵢₚ−v₂ as the velocity of the aircraft carrier 6, and, from the pilot's point of view, the SRW scale 34 and the SRW 32 were coincident.

At step s22, the pilot 20 controls the aircraft 2 dependent upon the displayed speed error scale 60. In particular, during the aircraft descent, the pilot 20 notices that the SRVV scale 34 is drifting with respect to the light emitters 14, and controls the aircraft 2 to adopt a shallower or steeper descent slope, and thereby causing the SRVV 32 to be vertically offset (i.e. misaligned) from the SRW scale 34.

This offsetting of the SRW 32 from the SRVV scale 34 may be performed by the pilot 20 aligning the FPM 36 with one of the dots of the ship speed error scale 60 (i.e. either the first dot 63, the second dot 64, the third dot 65, or the fourth dot 66). The pilot 20 may decide which dot 63-66 of the ship speed error scale 60 to align the FPM 36 with using his/her experience. The pilot 20 may decide which dot 63-66 of the ship speed error scale 60 to align the FPM 36 with based on his/her assessment of how quickly the SRVV scale 34 is drifting with respect to the light emitters 14. For example, based on the drifting of the SRVV scale 34, the pilot 20 may suspect that the ship speed provided by the aircraft carrier 6 is the first predetermined amount (e.g. 5 knots) less than the actual speed of the aircraft carrier 6. The pilot 20 may then control the aircraft 2 such that the FPM 36 is aligned with the first dot 63. This alignment of the FPM 36 with the first dot 63 causes the SRVV 32 to be shifted vertically with respect the SRVV scale 34. The SRW scale 34 would then tend to cease drifting with respect the light emitters 14 if the ship speed provided by the aircraft carrier 6 was indeed the first predetermined amount less than the actual speed of the aircraft carrier 6.

Preferably, the pilot 20 iteratively adjusts the position of the FPM 36 with respect to the ship speed error scale 60 until the drifting of the SRVV scale 34 with respect to the light emitter ceases.

At step s24, if the error in the ship speed provided by the aircraft carrier 6 is above a threshold value, the pilot 20 may perform a certain action. For example if, in order to stop the SRVV scale 34 drifting with respect to the light emitters 14, the FPM 36 has to be shifted away from the dash 62 beyond the third or fourth dots 65, 66 (and thus, the error in the ship speed provided by the aircraft carrier 6 is above the second predetermined value, e.g. greater than 10 knots), the pilot 20 may abort the landing.

Otherwise, if the error in the ship speed provided by the aircraft carrier 6 is within an allowable range (e.g. ±10 knots), the pilot 20 may maintain the position of the FPM 36 and SRVV 32 on the helmet mounted display 24 and land the aircraft 2 on the runway 4.

After step s24, the process of FIG. 4 ends.

Returning to the case where, at step s18, it is determined that, during the aircraft's descent, the SRVV scale 34 does not drift with respect to the light emitters 14, at step s26 it is determined that there are no errors with the currently displayed HMD symbology, and the aircraft 2 is controlled to land on the runway by the pilot 20 as described earlier above with reference to FIG. 3.

After step s26, the process of FIG. 4 ends.

Thus, a process in which factors that adversely affect the displayed HMD symbology are determined and mitigated is provided. The above described method is an error diagnosis and mitigation process.

The above described apparatus and method advantageously tends to be capable of determining that errors have occurred in the display of HMD symbology. Furthermore, the above described apparatus and method advantageously tend to mitigate or correct for those errors.

The above described apparatus and method advantageously facilitate the pilot in the landing of the aircraft. Thus, safety tends to be improved. Also, the risk of damage to the aircraft or aircraft loss during landing due to HMD symbology errors, and/or other errors or faults, tends to be reduced or eliminated.

The above described further SRVV scale advantageously tends to aid the pilot in safely landing the aircraft when an error with the INS of the aircraft has occurred. SRW scales tend to be physiologically compelling for pilots, and, during landing, pilots tend to be tempted to align the SRVV scale with aim lights even if they are aware that an HMD symbology error (e.g. an INS error) has occurred. Thus, by providing the pilot with a correctly drawn SRVV scale, problems caused by pilots being tempted to align erroneous SRVV scales with the aim lights tend to be overcome.

The above described offset feature advantageously tends to aid the pilot in safely landing the aircraft when an HMD offset error has occurred. The above described offset feature advantageously indicates to the pilot a range of possible true positions for the SRVV scale, as well as the relative likelihoods of those positions.

The above described ship speed error scale advantageously tends to aid the pilot in safely landing the aircraft when an erroneous aircraft carrier speed has been used to generate the SRVV. During the aircraft's descent towards the runway, initially the pilot would position the SRVV onto the SRVV scale. If the ship speed used by the processor to generate the SRVV scale was accurate, the FPM would be aligned with the dash of the ship speed error scale, the SRVV scale would not vertically drift with respect to the aim lights, and the aircraft would be correctly established on the desired glide path. However, if the SRVV scale does vertically drift with respect to the aim lights during the descent, the pilot may offset the SRW with respect to the SRW scale by an amount above or below the SRVV scale, using the ship speed error scale to judge how far to offset the FPM for a given error. The ship speed error scale is a convenient tool that allows the pilot to quickly establish the aircraft on a desired glide path.

Furthermore, the ship speed error scale advantageously informs the pilot if a ship speed error above a predetermined threshold has occurred. The pilot may then take appropriate action (e.g. aborting the landing operation). In such a case, the FPM may be located beyond the “safe” range indicated by the ship speed error scale.

The above described additional HMD symbology is advantageously simple and therefore does not severely clutter the helmet mounted display and thereby confuse the pilot.

The above described additional HMD symbology is advantageously intuitive for the pilot.

Advantageously, the determination of the positions on the display of the above described further SRVV scale, offset feature, and ship speed scale, uses only a few simple additional parameters compared to those used conventionally. These additional parameters tend mostly to be fixed values which tend not to be prone to errors. Apparatus, including the processor, for implementing the above arrangement and performing the above described method steps may be provided by configuring or adapting any suitable apparatus, for example one or more computers or other processing apparatus or processors, and/or providing additional modules. The apparatus may comprise a computer, a network of computers, or one or more processors, for implementing instructions and using data, including instructions and data in the form of a computer program or plurality of computer programs stored in or on a machine readable storage medium such as computer memory, a computer disk, ROM, PROM etc., or any combination of these or other storage media.

In the above embodiments, the aircraft is to be landed on an aircraft carrier. However, in other embodiments the aircraft is to be landed on land, on an aircraft, or on a water-based vehicle or amphibious vehicle other than an aircraft carrier.

In the above embodiments, the processor is located onboard the aircraft. However, in other embodiments, at least part of the processor is located remotely from the aircraft, for example, onboard the aircraft carrier.

In some embodiments, the HMD is a display only. However, in other embodiments, feedback from the helmet and/or the HMD, including but not limited helmet tracking devices onboard the aircraft for determining the pilot's head orientation and position within the aircraft cockpit, may be used to determine how the symbology is displayed.

In the above embodiments, symbology for aiding the pilot is displayed to the pilot on a helmet mounted display. However, in other embodiments, the symbology is displayed on a different type of display, for example, a cockpit panel display.

In the above embodiments, the HMD symbology includes the SRVV, the SRVV scale, the FPM, and the horizon bars. However, in other embodiments, the symbology displayed to the pilot includes one or more additional symbology objects instead of or in addition to one or more of those displayed in the above embodiments.

In some embodiments, some or all of the HMD symbology has a different size or shape to that described above. For example, in some embodiments, the SRVV scale is a solid horizontal line across the display and/or the FPM is a cross-hair.

In some embodiments, the HMD symbology displayed to the pilot is to be used in a different way to that described above during the landing operation.

In the above embodiments, the further SRVV is calculated by the processor as described in more detail earlier above and displayed on the helmet mounted display as a horizontal dashed line. However, in other embodiments, the further SRVV scale is determined in a different appropriate way, for example, using one or more different formulae instead of or in addition to those described above. In some embodiments, the further SRVV scale is not a horizontal dashed line, for example, the SRVV scale may be a solid horizontal line across the display.

In the above embodiments, the offset feature is calculated by the processor as described in more detail earlier above and displayed on the helmet mounted display as a V-shaped object. However, in other embodiments, the further SRVV scale is determined in a different appropriate way, for example in some embodiments the offset scale is not indicative of the relative probabilities of the positions of the SRVV scale and, thus, the offset feature may be determined using an appropriately modified process. In some embodiments, the offset feature is not a V-shaped object, for example, the SRVV scale may be a vertical error bar.

In the above embodiments, the ship speed error scale is calculated by the processor as described in more detail earlier above and displayed on the helmet mounted display as a series of dashes/dots. However, in other embodiments, the ship speed error scale is determined in a different appropriate way, for example, using one or more different formulae instead of or in addition to those described above. In some embodiments, the offset feature is not a series of dashes/dots, for example, the SRVV scale may be a vertical bracket within which the position of the FPM is allowed to be varied.

1. A method for displaying an image to a pilot of an aircraft, the method comprising:
displaying, by a helmet mounted display, to the pilot of the aircraft, an image comprising one or more initial image components, the one or more initial image components including a first image component;
providing, to one or more processors, an indication that the helmet mounted display is offset from a desired position for the helmet mounted display, the desired position of the helmet mounted display being a position in which, when the pilot controls the aircraft to perform a predefined operation, from the pilot's point of view, an initial image component displayed on the helmet mounted display is at a predefined position relative to one or more objects or features that are remote from the aircraft;
determining, by the one or more processors, a specification for a further image component; and
responsive to the one or more processors receiving the indication, displaying, by the helmet mounted display, to the pilot of the aircraft, an image comprising at least the first image component and the further image component; wherein
the further image component has a fixed position on the helmet mounted display with respect to the first image component and indicates, to the pilot, one or more alternative positions on the helmet mounted display for the first image component.

2. A method according to claim 1, wherein the step of determining the specification for the further image component comprises:
providing a value for a distance by which the helmet mounted display is offset from the desired position for the helmet mounted display; and
using the provided distance value, determining the specification for the further image component.

3. A method according to claim 1, wherein the further image component further indicates, to the pilot, the relative probabilities of the one or more alternative positions for the first image component being the same as the position that the first image component would have if, were the pilot to control the aircraft to perform the predefined operation, from the pilot's point of view, an initial image component was at the predefined position relative to the one or more objects or features that are remote from the aircraft.

4. A method according to claim 3, wherein
the further image component indicates, to the pilot, a plurality of alternative positions on the helmet mounted display for the first image component with respect to the objects or features that are remote from the aircraft; and
the step of determining the specification for the further image component comprises:
for each of the alternative positions for the first image component, providing a value for a probability that that position for the first image component is the same as the position that the first image component would have if, were the pilot to control the aircraft to perform the predefined operation, from the pilot's point of view, an initial image component was at the predefined position relative to the one or more objects or features that are remote from the aircraft; and
using the provided probability values, determining the specification for the further image component.

5. A method according to claim 1, wherein
the further image component is a V-shaped symbol;
the length of the V-shaped symbol indicates a range of alternative positions for the first image component with respect to the objects or features that are remote from the aircraft, the length of the V-shaped symbol being a distance between the tip of the V-shaped symbol and the ends of the arms of the V-shaped symbol; and
the distance between the arms of the V-shaped symbol at a point along the length of the V-shaped symbol indicates a relative probability that the alternative position for the first image component corresponding to that point along the length of the V-shaped symbol is the same as the position that the first image component would have if, were the pilot to control the aircraft to perform the predefined operation, from the pilot's point of view, an initial image component was at the predefined position relative to the one or more objects or features that are remote from the aircraft.
A method according to claim 1, wherein the first image component is a Ship Reference Velocity Vector scale for aiding the pilot to land the aircraft.

7. A method according to claim 1, wherein:
the first image component is a linear object that extends horizontally across at least part of the display; and
the further image component indicates one or more alternative vertical positions on the helmet mounted display for the first image component.

8. A method according to claim 1,
wherein the step of providing the indication to the processor comprises:
controlling, by the pilot, the aircraft to operate in a straight and level state;
determining that, during the straight and level state, one or more of the initial image components do not, from the pilot's point of view, coincide with a corresponding object or feature remote from the aircraft; and
responsive to the determination that, from the pilot's point of view, one or more initial image components do not coincide with a corresponding object or feature remote from the aircraft, providing, to the processor, the indication.

9. A method according to claim 8, wherein the step of determining that, during the straight and level state, one or more initial image components do not, from the pilot's point of view, coincide with a corresponding object or feature remote from the aircraft comprises determining, by the pilot, that, during the straight and level state, one or more horizon bars displayed on the helmet mounted display do not, from the pilot's point of view, coincide with the horizon as seen by the pilot through the helmet mounted display.

10. A method according to claim 1, wherein the processor is wholly located onboard the aircraft.

11. A method according to claim 1, the method further comprising controlling, by the pilot, the aircraft dependent upon the displayed further image component.

12. Apparatus for displaying an image to a pilot of an aircraft, the apparatus comprising:
a helmet mounted display configured to display, to the pilot of the aircraft, an image comprising one or more initial image components including a first image component; and
one or more processors configured to:
receive an indication that the helmet mounted display is offset from a desired position for the helmet mounted display, the desired position of the helmet mounted display being a position in which, when the pilot controls the aircraft to perform a predefined operation, from the pilot's point of view, an initial image component displayed on the helmet mounted display is at a predefined position relative to one or more objects or features that are remote from the aircraft; and
determine a specification for a further image component; wherein
the helmet mounted display is further configured to, responsive to the indication being received by the one or more processors, to the pilot of the aircraft, display an image comprising the first image component and the further image component; and
the further image component has a fixed position on the helmet mounted display with respect to the first image component and indicates, to the pilot one or more alternative positions on the helmet mounted display for the first image component.

13. An aircraft comprising apparatus according to claim 12.

14. A program or plurality of programs arranged such that when executed by a computer system or one or more processors it/they cause the computer system or the one or more processors to operate in accordance with the method of claim 1.

15. A machine readable storage medium storing said program or at least one of the plurality of programs according to claim 14.
